(19) United States
(12) Patent Application Publication
(10) Pub. No.: US 2026/0086747 A1
(43) Pub. Date: Mar. 26, 2026

(54) INTELLIGENT ADAPTIVE SECURITY, WITH BETTER ACCURACY THROUGH AGGREGATING USER’S ACCESS BEHAVIORS ACROSS MULTIPLE SITES USING TRANSFER LEARNING TECHNIQUE

(71) Applicant: Konica Minolta Business Solutions U.S.A., Inc., Ramsey, NJ (US)

(72) Inventor: Rahul SURAPARAJU, Fremont, CA (US)

(73) Assignee: Konica Minolta Business Solutions U.S.A., Inc., Ramsey, NJ (US)

(21) Appl. No.: 18/898,269

(22) Filed: Sep. 26, 2024

(51) Int. Cl. G06F 3/12; G06F 21/31

(52) U.S. Cl. CPC G06F 3/1238; G06F 3/1222; G06F 21/316; G06F 2221/2141

(57) ABSTRACT

A method is disclosed for adaptive security that includes receiving, on a first computer system, an access behavior of a user; inputting, by the first computer system, the received access behavior of the user into an artificial intelligence-powered identity and access management system; receiving, by the first computer system, a determination from a security model of the artificial intelligence-powered identity and access management system if the user is authorized to access a service or application based on the received access behavior of the user; and updating, by the first computer system, the security model of the artificial intelligence-powered identity and access management system based on the access behavior of the user and other users.

### FIELD OF THE DISCLOSURE

The present disclosure generally relates to a method and system for automated adaptive security and more particularly, a method and system for intelligent adaptive security, with better accuracy through aggregating access behaviors of users across multiple sites using transfer learning technique.

### BACKGROUND

Modern workforce keeps evolving at a faster rate. The enterprise users are more mobile now, same user uses a series of different devices during the same day. The user is more occupied with the real business in such a different work-style, than worrying about the satisfying the security and access control requirements. Besides the user perspective, network administrators are now scarce and if available, the administrators may not have the required expertise on when and how to take action, for example, on a bad actor or rogue user.

In addition, today's IAM-based solutions (Identity and Access Management-based solutions) on adaptive security (even the Intelligent ones that uses artificial intelligent (AI) technology) and multi-factor authentication (MFA) are not ideal in the sense that they either lack automation at the cost of security or lack security at the cost of automation.

### SUMMARY

In consideration of the above issues, it would be desirable to have a method and system for automated adaptive security or intelligent adaptive security, in which a system is equipped with required intelligence to spot the bad users trying to maliciously attack/access, for example, business-critical security assets (applications (apps), physical location etc.). In addition, since the system can be automated, the response time performance can be split-second compared to otherwise manual monitoring and remediation solutions.

In accordance with an aspect, a method for adaptive security comprising: receiving, on a first computer system, an access behavior of a user; inputting, by the first computer system, the received access behavior of the user into an artificial intelligence-powered identity and access management system; receiving, by the first computer system, a determination from a security model of the artificial intelligence-powered identity and access management system if the user is authorized to access a service or application based on the received access behavior of the user; and updating, by the first computer system, the security model of the artificial intelligence-powered identity and access management system based on the access behavior of the user and other users.

In accordance with another aspect, a non-transitory computer-readable storage medium having program instructions embodied therewith, the program instructions executable by a computer to cause the computer to perform a process for adaptive security, the process comprising: receiving an access behavior of a user; inputting the received access behavior of the user into an artificial intelligence-powered identity and access management system; receiving a determination from a security model of the artificial intelligence-powered identity and access management system if the user is authorized to access a service or application based on the received access behavior of the user; and updating the security model of the artificial intelligence-powered identity and access management system based on the access behavior of the user and other users.

In accordance with a further aspect, a multifunction printer comprising: a processor configured to: receive an access behavior of a user; input the received access behavior of the user into an artificial intelligence-powered identity and access management system; receive a determination from a security model of the artificial intelligence-powered identity and access management system if the user is authorized to access a service or application based on the received access behavior of the user; and update the security model of the artificial intelligence-powered identity and access management system based on the access behavior of the user and other users.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system for automated adaptive security in accordance with an exemplary embodiment.

FIG. 2 is an illustration of a multifunction printer in accordance with an exemplary embodiment.

FIG. 3 is an illustration of an intelligent adaptive security system in accordance with an exemplary embodiment.

FIG. 4 is an illustration of pre-artificial intelligence (pre-AI) based adaptive security deployment with local learning phases.

FIG. 5 is an illustration of a pre-AI based adaptive security deployment with transfer learning.

FIG. 6 is an illustration of a final deployment phase in accordance with an exemplary embodiment.

FIG. 7 is a method for adaptive security in accordance with an exemplary embodiment.

FIG. 8 is an illustration of an exemplary hardware architecture for an embodiment of a computer system for an intelligent adaptive security system.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

In accordance with an exemplary embodiment, the method and system for automated adaptive security can include, for example, an artificial intelligence (AI) based model that has a been prepared based on at least one dataset to learn, for example, a deep learning-based model. For example, uses can be any related pre-learnt model towards transfer learning to increase model's accuracy (i.e., more data, better model). In addition, access behavior and patterns of users can be constantly monitored by an AI-engine, which performs series of analytics. Works on a decision engine towards quicker inference on access abnormalities. Also, any newly learnt pattern/behavior manifests into continuous learning that can possibly be used towards a next better model.

In accordance with an embodiment, the method and system for automated adaptive security articulates an all-seamless and all-automatic intelligent adaptive security by carefully crafting a set of technologies to converge together that can include, for example, zero-trust, artificial intelligent (AI), decision trees-based security posture model, continuous learning and transfer learning.

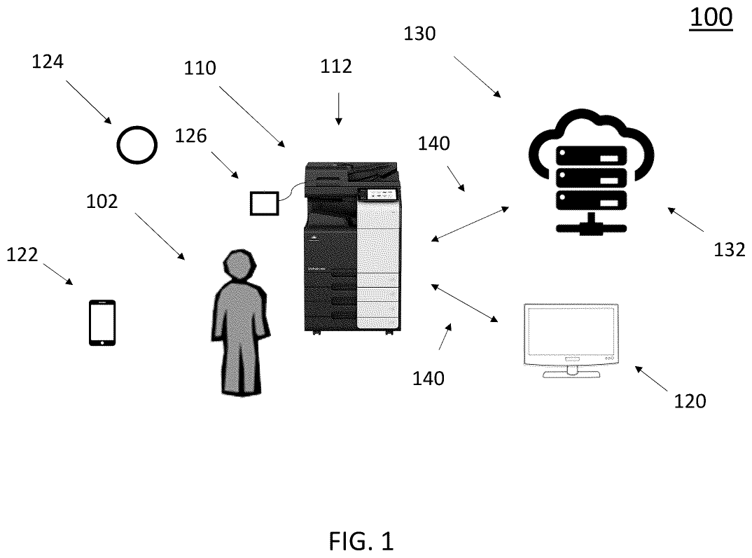

FIG. 1 is an illustration of a system 100 for adaptive security of a computer system 110 in the form of a multifunction printer 112 in accordance with an exemplary embodiment. As shown in FIG. 1, the system 100 can include one or more computer systems 110, a personal computer 120, a client device 122, and a remote server (or cloud computing environment) 130. The one or more computer systems 110 can be, for example, printers or multifunction printers (hereinafter “multifunction printers (MFPs)) 112. The system 100 is configured so that a user 102 can be authenticated on the one or more computer systems 110.

The system 100 can also include one or more users 102 that can be authenticated on the one or more computer systems 110, for example, a multifunction printer 112, by entry of personal identification number or use of public key infrastructure (PKI) card on the one or more computer systems 110, or via an authentication process using, for example, a personal computer 120, a client device 122, a biometric identifier 124, or other authenticator or biometric of the user 102. For example, the user 102 may be authenticated on the one or more computer systems 110 via, for example, a fingerprint reader 126 associated with the one or more computer systems 110. In accordance with an embodiment, the client device 122 can be, for example, a mobile client, for example, a smart phone, a smart tablet, a smart watch, or a biometric band or the like. The authentication of the user 102 on the one or more computer systems 110 can be, for example, for access to the multifunction printer 112. The cloud computing environment 130 can include, for example, one or more servers 132 running in a cloud computing environment that can be accessed by the one or more multifunction printers 110.

The one or more computer systems 110, the personal computer 120, the client device 122, and the one or more servers 132 of the cloud computing environment 130 can include a processor or central processing unit (CPU), and one or more memories for storing software programs and data. The processor or CPU carries out the instructions of a computer program, which operates and/or controls at least a portion of the functionality of the one or more multifunction printers 110, the personal computer 120, the client device 122, and the cloud computing environment 130. The one or more computer systems 110, the personal computer 120, the client device 122, and the one or servers 132 of the cloud computing environment 130 can also include an operating system (OS), which manages the computer hardware and provides common services for efficient execution of various software programs. For example, the software programs can include application software, for example, for managing an authentication module and/or biometric identifier, for example, for the one or more computer systems 110, the personal computer 120, the client device 122, and the cloud computing environment 130.

In accordance with an embodiment, the one or more computer systems 110, for example, in the form of a multifunction printer 112 can be configured to host, for example, managed print services (MPS). The managed print services can include, for example, one or more of user authentication, monitoring and reporting, user and cost management, cost accounting and budget management, printer queue management, and workflow management. For example, user authentication can include control over identities of user, which can help ensure that users 102 have been authenticated before a print job is released and/or printed. The monitoring and report features can allow administrators to track and monitor usage in real time through regular, scheduled and on-demand reporting. The user and cost management feature can help manage and charge back costs by assigning users to cost centers, or enabling them to select the relevant cost center, billing codes, or project codes before printing a document. In addition, the user and cost management feature can be used to create print rules or policies, which can help ensure tighter cost management by allowing different user roles to access different devices and features. For example, the user and cost management feature can control, for example, duplex printing and/or color printing to individuals and/or groups.

In addition, cost accounting and budget management provides for cost control and flexibility, which can be used as a print management solution that allows administrators to assign print budgets to users, with the option to top up their accounts. For example, in an environment such as a university, for example, this allows administrators to give students a free print quota that they can add to as required. In addition, a print queue management can be used for management of individual production in addition to office print queues in an office, for example.

Alternatively, the one or more computer systems 110 and the automated adaptive security system as disclosed herein can be utilized for users 102 that may be required to login to access a home or office security system, which can used for accessing the home or office, for example, via a door to the building, a floor or room of the home or office, via, for example, an elevator, and/or any other secured room. The one or more computer systems 110 can also be used in securing device, for example, security systems, and computers, within the user's home or office, for example, a medical office and medical records or personal information of users.

The one or more computer systems 110, the personal computer 120, the client device 122, and the cloud computing environment 130 can be connected via a communication network 140. The communication network 140 may include, for example, a conventional type of network, wired or wireless, and may have any number of configurations, such as a star configuration, token ring configuration, or other known configurations. The communication network 140 may include one or more local area networks (“LANs”), wide area networks (“WANs”) (e.g., the Internet), virtual private networks (“VPNs”), peer-to-peer networks, near-field networks (e.g., Bluetooth®), cellular networks (for example, 3G, 4G, 5G, other generations), and/or any other interconnected data path across which multiple computing nodes may communicate.

In accordance with an exemplary embodiment, the user 102 can present an authenticator to the one or more computer systems 110, the client device 122, and/or from the biometric authenticator 124 for access to the one or more multifunction printers 110. For example, the authentication of the user 102 on the one or more computer systems 110 can be based on the biometrics of the user 102 via a fingerprint scanner, an IC card or smart card, or other authenticators. In accordance with an exemplary embodiment, the authenticator can be via, for example, a security identification and authentication device (or authenticator), which uses automated methods of verifying or recognizing the identity of a living person based on a physiological or behavioral characteristic. Thus, the user 102 may not be required to manually input passwords to the one or more multifunction printers 110. The method of recognizing the user 102 can include, for example, fingerprints, electrocardiogram (ECG or EKG) information, facial images, iris, and voice recognition. For example, in accordance with an exemplary embodiment, the biometric authenticator 124 can be a wearable device, for example, a Nymi™ band, which detection of the user 102 is based on the electrocardiogram (ECG) and its unique properties, e.g., electrical activity of the heartbeat of the user (e.g., wearer) 102 can be used as an authenticator.

Authentication via the client device 120 can also include the presentation, for example, of the client device 122, for example, a mobile device, a smart phone, and/or smart watch of the user 102 to a vicinity of an authenticator (e.g., client device 120) via a near-field communication (NFC) network (e.g., Bluetooth®) and wherein the user 102 has previously been authenticated on the client device 122, for example, the mobile device or smart phone by one or more of a user identifier (ID) and password and/or a biometric identifier, for example, facial recognition, fingerprint, of the like.

In accordance with an exemplary embodiment, the authentication of the user 102 on the client device 120 can be a biometric identifier, which is a distinctive, measurable characteristics used to label and describe or identify an individual, including a metric related to human characteristics. For example, the biometric identifier can include physiological characteristics of an individual including but not limited fingerprints, palm veins, face recognition, DNA (or deoxyribonucleic acid), palm print, hand geometry, iris recognition, retina, and/or odor/scent.

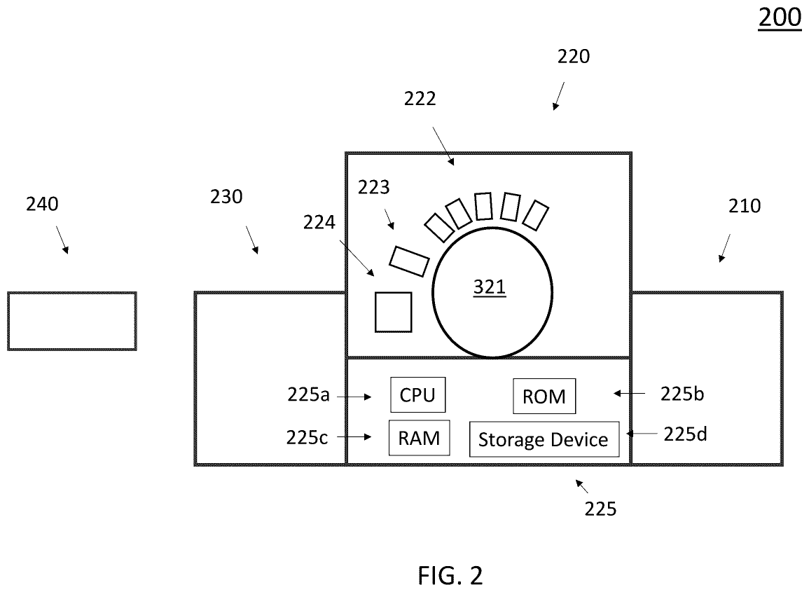

FIG. 2 is an illustration of a multifunction printer 200 in accordance with an embodiment. The multifunction printer 200 can include a sheet feeding device 210, a printer 220, a sheet ejection device 230, and an optional colorimeter 240. The sheet feeding device 210, the printer 220, and the sheet ejection device 230 are connected and disposed in this order from an upstream side to a downstream side in a conveyance direction of a recording medium. The sheet feeding device (an example of a recording medium supply device) can include a container (sheet feeding tray) that contains a recording medium and supplies the recording medium to the printer. The printer 220 can bey, for example, a one-pass UV inkjet printer, and can include a main cylinder 221, a plurality of head units 222, an irradiation unit 223, a scanner 224, and an information processing unit 225. The multifunction printer 220 is not limited to the one-pass UV inkjet printer, and may be, for example, an image forming apparatus that forms an image on a recording medium by an electrophotographic method other than the one-pass UV inkjet printer.

The main cylinder 221 is formed of a cylindrical member and is rotated counterclockwise in the drawing by a drive motor. The main cylinder 221 holds the recording medium along a cylindrical outer peripheral surface and conveys the recording medium along with the rotation of the cylinder. A conveying surface of the main cylinder 221 faces the plurality of head units 222, the irradiation unit 223, and the scanner 224, and the head units 222 and the irradiation unit 223 perform processing related to image formation on the recording medium conveyed by the main cylinder 221. The scanner 224 scans the recording medium on which the image is formed and reads the image (print image) formed on the recording medium. The plurality of head units 222 form an image by ejecting ink droplets to a recording surface of the recording medium moving according to the rotation of the main cylinder 221 at an appropriate timing and causing the ink droplets to land on the recording target surface of the recording medium. The plurality of head units 222 can include, for example, four or five head units 222 that respectively eject inks of four or 5 colors. For example, the four head units 222 include, for example, head units that respectively discharge Y (yellow), M (magenta), C (cyan), and K (black) inks.

The irradiation unit 223 can include, for example, a fluorescent tube such as a low-pressure mercury lamp and causes the fluorescent tube to emit light to emit energy rays such as ultraviolet rays. The irradiation unit 223 is provided near the outer peripheral surface of the main cylinder 221 and at a position on the downstream side of the head unit 222 in the conveyance direction of the recording medium. Furthermore, the irradiation unit 223 irradiates the recording medium held by the main cylinder 221 and onto which the ink has been discharged with energy rays to cure the ink.

The scanner 224 is an example of an image reader including an image sensor or the like, reads a recording medium on which an image is formed, for example, a test sheet for colorimetry on which a plurality of patches is formed, and outputs a read image to the information processing unit 225.

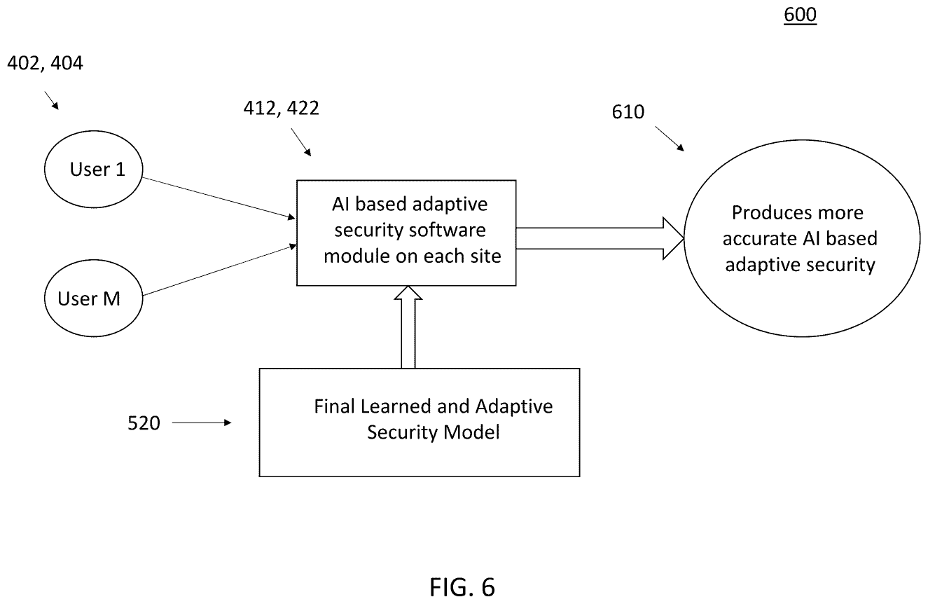

The information processing unit 225 includes a central processing unit (CPU) 225a, a read only memory (ROM) 225b, a random-access memory (RAM) 225c, and a storage device 225d. The information processing unit 225 can includes, for example, a microprocessor or the like, and performs overall control of the printer 220. The information processing unit 225 can be configured inside the printer 220, or alternatively, the information processing unit 225 may be configured, for example, in a personal computer (PC) provided outside the printer 220 and capable of communicating with the printer 220. The CPU 225a controls an operation of the information processing unit 225. The CPU 225a controls, for example, operations of the main cylinder 221, the head units 222, and the irradiation unit 223 to control image forming processing in the printer 220. Furthermore, the CPU 225a controls reading processing on a recording medium on which an image is formed in the scanner 24. Furthermore, the CPU 25a controls colorimetric processing (see FIG. 6 described later) in the information processing unit 25.

The ROM 225b includes, for example, a storage medium such as a nonvolatile memory, and stores programs, data, and the like executed and referred to by the CPU 225a. The ROM 225b is used as an example of a computer-readable non-transitory storage medium storing the program to be executed by the information processing unit 225. The RAM 225c can include, for example, a storage medium such as a volatile memory, and temporarily stores information (data) necessary for processing performed by the CPU 225a.

The storage device 225d is constituted by a computer-readable non-transitory recording medium storing the program to be executed by the CPU 225a and is constituted by a storage device such as a hard disk drive (HDD). The storage device stores a program for the CPU 225a to control each unit, an operating system (OS), a program such as a controller, and data. Note that, a part of the program and data stored in the storage device may be stored in the ROM 225b. Furthermore, the computer-readable non-transitory recording medium storing the program executed by the CPU 225a is not limited to the HDD, and may be a recording medium such as a solid-state drive (SSD), a compact disc (CD)-ROM, or a digital versatile disc (DVD)-ROM. The sheet ejection device 230 includes a container (sheet ejection tray) that contains a recording medium, and stores the recording medium ejected from the printer 220, on which an image is formed,

The colorimeter 240 can include, for example, a spectral colorimeter capable of simultaneously measuring color and gloss and measures a colorimetric value of the test sheet as a pixel value in a color space. Furthermore, the colorimeter 240 outputs the measured colorimetric value of the test sheet, that is, each pixel value, for example, in the Lab color space to the information processing unit 225 of the printer 220 via a universal serial bus (USB) connection port, a local area network (LAN), or the like.

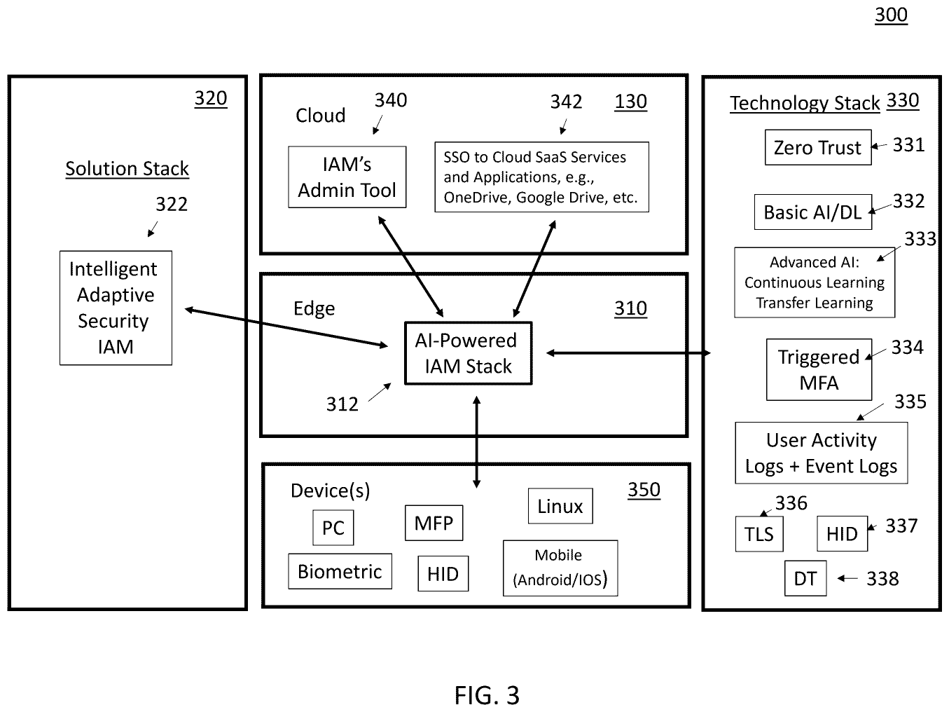

FIG. 3 is an illustration of an intelligent adaptive security system 300 in accordance with an embodiment. As shown in FIG. 3, the intelligent adaptive security system 300 can include an edge device 310 that hosts an artificial intelligence-powered identity and access management system 312, a solution stack 320, a technology stack 330, a cloud computing environment 130, and a plurality of devices 350. In accordance with an embodiment, the solution stack 320 and the technology stack 330 are hosted on a computer system 110, for example, within the multifunction printer 112, or on a cloud computing environment.

The edge device 310 can be a device that provides an entry point into enterprise or service provider core networks, for example, via a single sign-on (SSO) protocol to cloud based applications and services 342 hosted in the cloud computing environment 130. Examples of edge devices 310 can include, for example, routers, routing switches, integrated access devices (IADS), multiplexers, and a variety of metropolitan area network (MAN) and wider area network (WAN) access devices. The edge device 310 can also provide connections into carrier and service provider networks. In addition, the edge device 310 can include an edge gateway layer that consists of a data aggregation system that can provide functionality, such as pre-processing of the data, securing connectivity, for example, to the cloud computing environment 340, using for example, systems such as WebSocket, an event hub, edge analytics or fog computing.

In accordance with an exemplary embodiment, the edge device 310 includes an artificial intelligence-powered identity and access management (IAM) system (or stack) 312 that is configured to be updated by an intelligent adaptive security identity and access management (IAM) system 322 that is hosted on the solution stack 320. In accordance with an embodiment, the intelligent adaptive security identity and access management system 322 can update the artificial intelligence-powered identity and access management system (or stack) 312 on a set basis, for example, monthly, weekly, daily, hourly, or a continuous basis. For example, the continuous updating of the artificial-intelligence-powered identity and management system (or stack) 312 can be based upon each time that an artificial intelligence model or models associated with the intelligent adaptive security identity and access management system 322 is updated with a dataset from the technology stack 320 including one or more of the plurality of technologies within the technology stack 330.

In accordance with an embodiment, the intelligent adaptive security identity and access management system 322 can configured based on artificial intelligence models that includes datasets from a plurality of technologies. For example, the plurality of technologies received, for example, from the technology stack 330. The plurality of technologies can include, for example, a zero-trust model (i.e., single sign-on model, federation protocol (or federated authentication protocols) 331, an artificial intelligence model including deep learning 332, an advanced artificial intelligence with continuous learning and transfer learning 333, triggered multifactor authentication systems 334, data related to user activity includes logs and event logs 335, data associated with transfer layer security (TLS) protocol 336, human interface device security models 337, and decision tree-based security posture 338 that are input into the intelligent adaptive security identity and access management system 322 that can utilize the plurality of technologies including a set of modern log analytics, pattern learning through access attempts, and taking into consideration client device posture, for example, in a decision tree.

In accordance with an embodiment, the zero-trust model 331 can include any network security model that assumes no one or anything should be trusted by default, and that all attempts to access a network are threats. For example, in accordance with an embodiment, the technology stack 330 can include a zero-trust (or single sign-on (SSO)) technology 331, which can be maintained by a separate organization using Federated Identity Management (FIM) technologies such as SAML (SAML 2.0), OAuth, or OpenID.

In accordance with an embodiment, the artificial intelligence (AI) models 332 and advanced artificial intelligence models 333 can include the ability of a machine to perform tasks that are typically associated with intelligent beings, such as learning, reasoning, and discovering meaning and can include both basic artificial intelligence and deep learning. In addition, the artificial intelligence model 332 and advanced artificial intelligence models 333 can include continuous learning and/or transfer learning. For example, continuous learning can refer to the ability of artificial intelligence (AI) systems to acquire new knowledge, improve their performance, and adapt to changing conditions over time. In addition, transfer learning can be implemented that includes a machine learning technique that uses a model trained on one task to improve performance on a related task. For example, transfer learning can be a deep learning model, which can be useful when data is limited for a new task or when the tasks are similar.

In accordance with an embodiment, the technology stack 330 can include multifactor authentications protocols 334 that are trigger. For example, the triggered multifactor authentication protocol 334 can include a username and password in additional to additional authenticator. For example, the additional authenticator can include displaying, on a display panel of the multifunction printer 112, a screen prompting from the user 102, a biometric identifier. The biometric identifier of the user 102 can be one or more physiological characteristic of the user 102, and wherein the one or more physiological characteristic is selected from one or more of fingerprints, palm veins, face recognition, DNA (deoxyribonucleic acid), palm print, hand geometry, iris recognition, retina, and/or odor/scent; and authenticating, on the multifunction printer 112, the user 102 with the biometric identifier.

The technology stack 330 can also include user activity logs and event logs 335 that can be complied based on user activity. For example, if a user 102 logs into a computer system 110, each of the logins can be recorded into a log and specific activities can be logged for input into the intelligent adaptive security identity and access management system 322.

The technology stack 330 can also include transport layer security (TLS) information 336 and human interface devices (HID) 337. TLS 336 is a security protocol designed to facilitate privacy and data security for communications over the Internet. For example, a primary use case of TLS is encrypting the communication between web applications and servers, such as web browsers loading a website that can be tracked and monitored for security purposes as disclosed herein.

Meanwhile, usage of human interface devices (HID) 337 can be monitored and logged. For example, the HID 337 can be an entity that directly interacts with a human, such as a keyboard or mouse. A host device, for example, a computer system 110 can communicate with the HID 337 and receives input data from the HID 337 on actions performed by the user 102, which are input into the intelligent adaptive security identity and access management system 322 to help develop, for example, patterns of the user 102 that can be used with analytics for pattern learning through access attempts in communication with device posture of use based on TLS 336 and HID 337 of the user 102. In addition, the patterns of the user 102 can be utilized in decision tree-based security protocol 338.

In accordance with an embodiment, the technology stack 330 can include a decision trees-based security posture models 338, which can be security decision trees that model how an attack may unfold by using a tree structure. For example, the tree structure can help understand a mindset of an attacker and decision-making process prioritizing vulnerability patching. For example, the decision trees can help organizations categorize vulnerabilities into categories, which can include levels of attention and urgency required for each vulnerability. For example, a decision tree can also be used to evaluate whether a security service, for example, meets business or technical requirements of an authorization process. In addition, decision trees can help identify malicious activity and create technology-specific techniques to defend against attacks.

The cloud computing environment 130 can include one or more servers 132. In addition, the edge device 310 and the one or more servers 122 in the clouding computing environment 120 can be configured, for example, to be communicate with a computer system 110, which can be a personal computer (PC) 120, or a tablet or a smartphone 122. The cloud computing environment 130 can include one or more servers 132 that are configured to store, for example, an identity and access management administrative tool 340 and services and applications 342 including but not limited to single sign-on (SSO) to cloud services and application (e.g., Cloud SaaS Services and applications including OneDrive, Google Drive, etc.

In accordance with an exemplary embodiment, the intelligent adaptive security system 300 as disclosed herein can help address the modern workforce and the ability of enterprise users that are more mobile now than ever before and often users 102 uses a series of different devices 350 during the same day to access resources including services and application 342 hosted in cloud computing environments 130. In addition, the user 102 can also be more occupied with the real business in such a different work-style, than worrying about the satisfying the security and access control requirements. In addition, besides the user perspective, network administrators may not have the required expertise on when and how to take action on a bad actor or rogue user.

In accordance with an embodiment, the intelligent adaptive security system 300 provides a solution that offers automated adaptive security. The intelligent adaptive security system 300 can be equipped with required intelligence to spot the bad users trying to maliciously attack/access business-critical security assets (for example, applications, physical location, etc.) by utilizing artificial intelligence to capture a plurality of dataset from the technology stack 330 that can automatically updated an artificial intelligence-powered identity and access management system (or stack) 312 hosted on an edge device 310, which provides split-second response time to avoid unwanted attacks compared to otherwise manual monitoring and remediation.

In accordance with an embodiment, the intelligent adaptive security system 300 can include model preparation that prepare a base artificial intelligence (AI) model on adaptive security that includes datasets to learn, for example, a deep-learning-based model. In addition, the intelligent adaptive security system 300 can uses any related pre-learnt models in transfer learning to increase accuracy of the intelligent adaptive security system 300. For example, the intelligent adaptive security system 300 can include constantly monitoring by an artificial intelligence-engine (AI-engine) access behavior and patterns of users 102 using a series of analytics, and wherein the AI-engine works towards quicker inference on access abnormalities. In addition, any newly learnt pattern/behavior of users can be manifest into continuous learning that can possibly be used towards next better model. In addition, the intelligent adaptive security system 300 is a security approach that responds to potential cyberthreats in real-time by continually monitoring access behavior of the user 102 that is more user-friendly and secure than legacy security solutions.

In accordance with an embodiment, devices 350 can include one or more of a personal computer, a multifunction printer, a Linux based-device, a biometric device, a human interface device (HID), or a mobile device (e.g., with an Android or IOS operating system. For example, the HID can be a keyboard, a mouse, a keypad and the like.

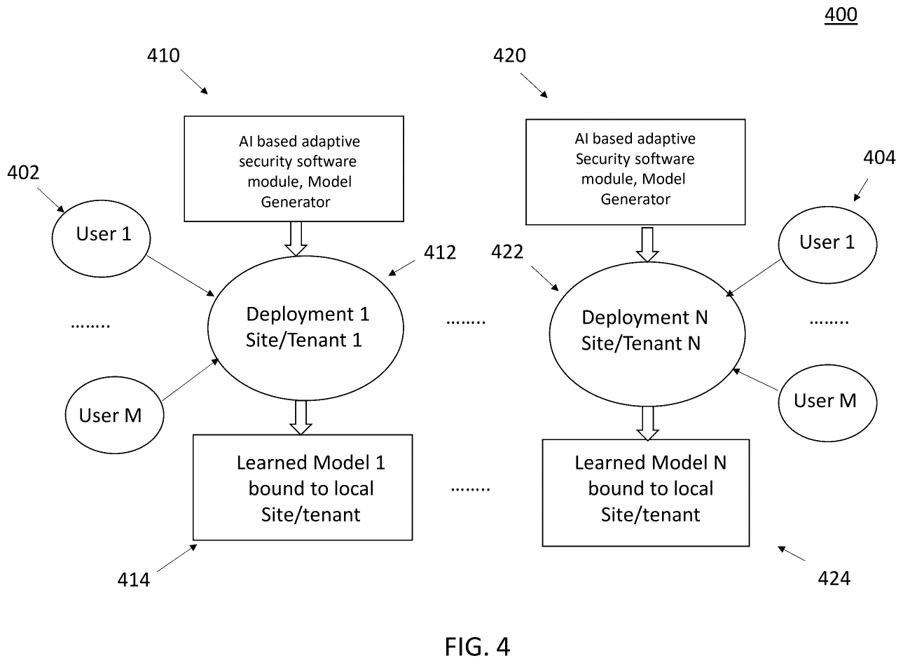

FIG. 4 is an illustration of pre-artificial intelligence (pre-AI) based adaptive security deployment with local learning phases 400. In accordance with an embodiment, the invention entails a new technique to achieve a bigger learning model help AI based adaptive security in offering better accuracy on inferences.

Modern computing landscape has users access multiple sites and multiple tenants deployed in distributed environments. Every time users 102 attempt to get access to services and applications, they are securely identified and authenticated by an identity and access management (IAM) solution before access is granted.

As shown in FIG. 4, a first phase includes a plurality of users 402 (e.g., User 1 to User M) and a plurality of users 404 (e.g., User 1 to User M). Each of the plurality of users 402, 404 are in one or more or more deployment sites or tenants 412, 422. Each of the one or more deployment sites or tenants 412, 422 includes a AI based adaptive security software module, model generator 410, 420. In accordance with an embodiment, the tenant can be a group of users who share a common access with specific privileges, for example, to services and applications. The AI based adaptive security software module, model generator 410, 420 receives access pattern behavior from the plurality of users 402, 404, for example, over a period of time or configurable number of days. The period of time can be, for example, days, weeks, or months. The AI based adaptive security software module, model generator 410, 420 generates a learned model bound to the local site or tenant 414, 424.

In accordance with an embodiment, the adaptive security embedded in such IAM solution, can use the technique wherein individual deep learning models learned across a set of deployments at various sites and/or tenants contribute to much bigger learned model through transfer learning. Each of the individual models represent the access pattern behavior by a set of users 102, that is learned over a period of configurable number of days (for example, 90 days).

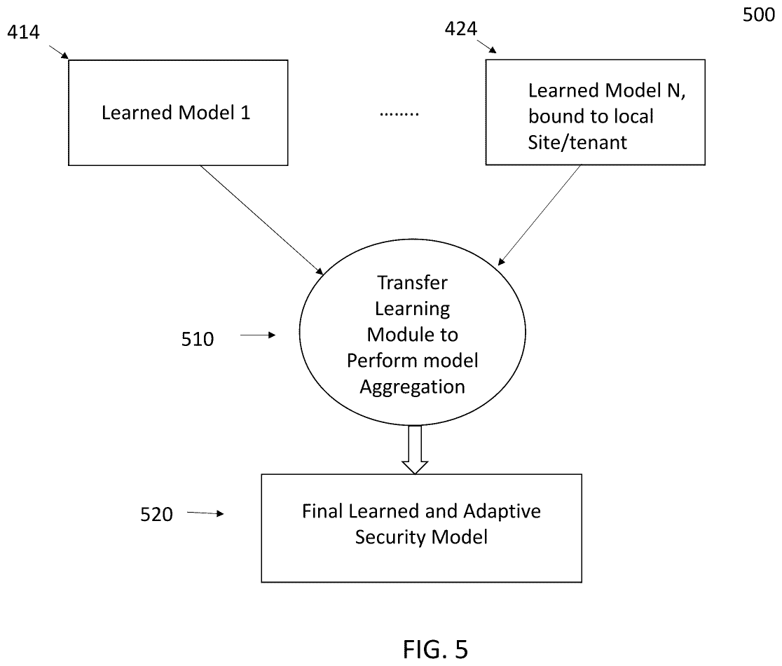

FIG. 5 is an illustration of a pre-AI based adaptive security deployment with transfer learning 500. As shown in FIG. 5, the learned models bound to the local sites or tenants 414, 424 can be input into a transfer learning module 510 to generate a final learned and adaptive security model 520.

In accordance with an embodiment, for example, after the configured number of days elapses, the administrator at each site and tenant 412, 422 can export the learned data model file 414, 424. Each such model file is input into transfer learning module 510 that performs processing by running one or more algorithms to aggregate the results in such a way that the final model is mathematically and model-wise representative of all individual models.

FIG. 6 is an illustration of a final deployment phase 600 in accordance with an exemplary embodiment. As shown in FIG. 6, the final learned and adaptive security model 520, for example, which is a computed big deep learning model is now ready for deployment to achieve adaptive security at each site/tenant 620. In accordance with an embodiment, the final learned and adaptive security model 520 can achieve better accurate inferences, and hence the inferences and decisions that drive the intelligent adaptive security 610 are more accurate than what would have been possible through individual site-bound or tenant-based data models.

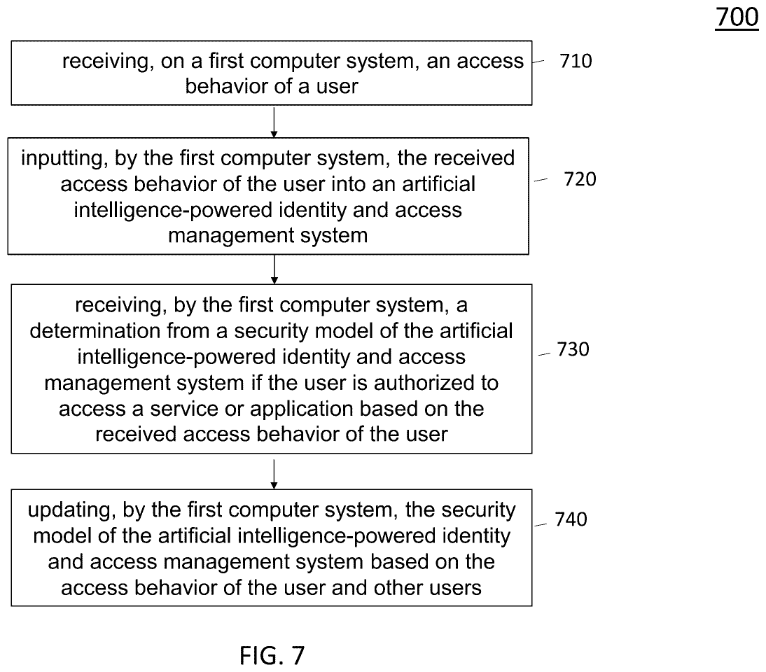

FIG. 7 is a method for adaptive security 700 according to an exemplary embodiment. As shown in FIG. 7, in step 710, an access behavior of a user 102 is received on a first computer system 310. In step 720, the received access behavior of the user 102 is input by the first computer system 310 into an artificial intelligence-powered identity and access management system 312. In step 730, a determination is received by the first computer system 310 from a security model of the artificial intelligence-powered identity and access management system 312 if the user 102 is authorized to access a service or application 342 based on the received access behavior of the user 102. In step 740, the security model of the artificial intelligence-powered identity and access management system 312 is updated by the first computer system 310 based on the access behavior of the user 102 and other users.

In accordance with another embodiment, the method 700 can include receiving, by the first computer system 310, the updates for the security model of the artificial intelligence-powered identity and access management system 312 from an intelligent adaptive security system (or intelligent adaptive security identity and access management (IAM) system) 322, the intelligent adaptive security system 322 configured to update the security model of the artificial intelligence-powered identity and access management system 312 based on the access behavior of the user 102 and the other users and learned models associated with an adaptive enforced security model for the user 102 and the other users. The artificial intelligence-powered identify and access management system 312 can be hosted on the first computer system 310.

In accordance with an embodiment, the updates for the security model of the artificial intelligence-powered identity and access management system 312 are based on data from the user 102 and the other users from one or more of a federation protocol, an artificial intelligence system with deep learning, triggered multi-factor authenticators, user activity from logs and event logs, transport layer security, human interface device, and decision tree-based security posture.

In accordance with an embodiment, the method further includes receiving, by the first computer system 310, the access behavior of the user 102 from a first device, the first device being one or more of a personal computer, a multifunction printer, a mobile device, a biometric device, a human interface device, or a Linux-based device. The method can also include receiving, by the first computer system 310, data from one or more of a federation protocol, an artificial intelligence system, a triggered multi-factor authenticator, user activity logs, transport layer security, and a human interface device, and forwarding, by the first computer system 310, the data from the one or more of the federation protocol, the artificial intelligence system, the triggered multi-factor authenticator, the user activity logs, the transport layer security, and the human interface device to the security model of the intelligent adaptive security system 322.

In accordance with an embodiment, the method further includes receiving, by the intelligent adaptive security system 322, data from one or more of a federation protocol, an artificial intelligence system, a triggered multi-factor authenticator, user activity logs, transport layer security, and a human interface device, and updating, by the intelligent adaptive security system 322, the security model of the advance artificial intelligence system 322 based on the data from the one or more of the federation protocol, the artificial intelligence system, the triggered multi-factor authenticator, the user activity logs, the transport layer security, and the human interface device. The method can also include storing, in a second computer system 130, an identity and access management administrative tool 340, and administering, by the second computer system 130, the artificial intelligence-powered identity and management system 312 with the identity and access management administrative tool 340.

In accordance with an embodiment, the received access behavior of the user 102 can include one or more of an authenticator from a smart card, a client device with an authentication application, a password-based authenticator, a biometric authenticator, and a geolocation-based authenticator.

In accordance with an embodiment, the method 700 further includes denying, by the first computer system 310, the user access to the service or application when the received access behavior of the user does not comply with a policy of the security model of the artificial intelligence-powered identity and access management system 312. The denial of the user to access the service or application can be based on a learned pattern or behavior of the user. The learned pattern or behavior of the user can be based, for example, on one or more of a type of client device with an authentication application and a geolocation-based authenticator.

In accordance with an embodiment, the denial of the user to access the service or application is based on a decision tree-based security protocol. For example, the decision tree-based security protocol can be based on client device posture.

In addition, the method can include detecting, by the first computer system 310, an attack on the service or application based on the received access behavior of the user when the received access behavior of the user does comply with the security model of the artificial intelligence-powered identity and access management system 312 for the user.

In accordance with an exemplary embodiment, the first computer system 310 can be a multifunction printer 112.

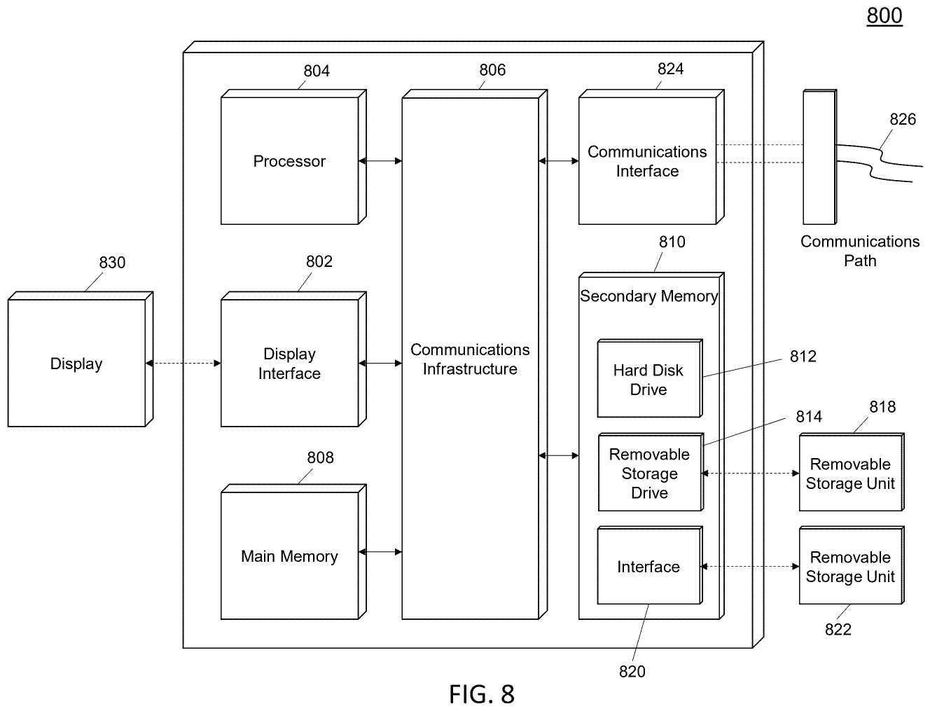

FIG. 8 illustrates a representative computer system 800 in which embodiments of the present disclosure, or portions thereof, may be implemented as computer-readable code executed on hardware. For example, the one or more printers or multifunction printers 110, 112, the personal computer 120, the client device 122, the wearable device 124, the fingerprint reader 126, the cloud computing environment 130, the one or more remoter servers 132, the edge device 310, the solution stack 320, the technology stack 330, the devices 340 associated with the method and system for automated adaptive security as disclosed herein may be implemented in whole or in part by a computer system 800 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above-described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this representative computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

A processor device 804 may be processor device specifically configured to perform the functions discussed herein. The processor device 804 may be connected to a communications infrastructure 806, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc. Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 1-7, as discussed herein. Accordingly, such computer programs may represent controllers of the computer system 800. Where the present disclosure is implemented using software executed on hardware, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software executed on hardware, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower-level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower-level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present disclosure may be implemented such that its software part has been written onto a recording medium in advance and will be read as required in operation.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S. C. § 112(f) unless traditional means-plus-function language is expressly recited, such as “means for” or “step for” language being expressly recited in the claim(s).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adaptive security comprising:
receiving, on a first computer system, an access behavior of a user;
inputting, by the first computer system, the received access behavior of the user into an artificial intelligence-powered identity and access management system;
receiving, by the first computer system, a determination from a security model of the artificial intelligence-powered identity and access management system if the user is authorized to access a service or application based on the received access behavior of the user; and
updating, by the first computer system, the security model of the artificial intelligence-powered identity and access management system based on the access behavior of the user and other users.

2. The method according to claim 1, further comprising:
receiving, by the first computer system, the updates for the security model of the artificial intelligence-powered identity and access management system from an intelligent adaptive security system, the intelligent adaptive security system configured to update the security model of the artificial intelligence-powered identity and access management system based on the access behavior of the user and the other users and learned models associated with an adaptive enforced security model for the user and the other users.

3. The method according to claim 1, further comprising:
hosting the artificial intelligence-powered identify and access management system on the first computer system.

4. The method according to claim 1, wherein the updates for the security model of the artificial intelligence-powered identity and access management system are based on data from the user and the other users from one or more of a federation protocol, an artificial intelligence system with deep learning, triggered multi-factor authenticators, user activity from logs and event logs, transport layer security, human interface device, and decision tree-based security posture.

5. The method according to claim 1, further comprising:
receiving, by the first computer system, the access behavior of the user from a first device, the first device being one or more of a personal computer, a multifunction printer, a mobile device, a biometric device, a human interface device, or a Linux-based device.

6. The method according to claim 1, further comprising:
receiving, by the first computer system, data from one or more of a federation protocol, an artificial intelligence system, a triggered multi-factor authenticator, user activity logs, transport layer security, and a human interface device; and
forwarding, by the first computer system, the data from the one or more of the federation protocol, the artificial intelligence system, the triggered multi-factor authenticator, the user activity logs, the transport layer security, and the human interface device to the security model of the intelligent adaptive security system.

7. The method according to claim 1, further comprising:
receiving, by the intelligent adaptive security system, data from one or more of a federation protocol, an artificial intelligence system, a triggered multi-factor authenticator, user activity logs, transport layer security, and a human interface device; and
updating, by the intelligent adaptive security system, the security model of the advance artificial intelligence system based on the data from the one or more of the federation protocol, the artificial intelligence system, the triggered multi-factor authenticator, the user activity logs, the transport layer security, and the human interface device.

8. The method according to claim 1, further comprising:
storing, in a second computer system, an identity and access management administrative tool; and
administering, by the second computer system, the artificial intelligence-powered identity and management system with the identity and access management administrative tool.

9. The method according to claim 1, wherein the received access behavior of the user includes one or more of an authenticator from a smart card, a client device with an authentication application, a password-based authenticator, a biometric authenticator, and a geolocation-based authenticator.

10. The method according to claim 1, further comprising:
denying, by the first computer system, the user access to the service or application when the received access behavior of the user does not comply with a policy of the security model of the artificial intelligence-powered identity and access management system.

11. The method according to claim 10, wherein the denial of the user to access the service or application is based on a learned pattern or behavior of the user.

12. The method according to claim 11, wherein the learned pattern or behavior of the user is based on one or more of a type of client device with an authentication application and a geolocation-based authenticator.

13. The method according to claim 10, wherein the denial of the user to access the service or application is based on a decision tree-based security protocol.

14. The method according to claim 13, wherein the decision tree-based security protocol is based on client device posture.

15. The method according to claim 1, further comprising:
detecting, by the first computer system, an attack on the service or application based on the received access behavior of the user when the received access behavior of the user does comply with the security model of the artificial intelligence-powered identity and access management system for the user.

16. The method according to claim 1, wherein the first computer system is a multifunction printer.

17. A non-transitory computer-readable storage medium having program instructions embodied therewith, the program instructions executable by a computer to cause the computer to perform a process for adaptive security, the process comprising:
receiving an access behavior of a user;
inputting the received access behavior of the user into an artificial intelligence-powered identity and access management system;
receiving a determination from a security model of the artificial intelligence-powered identity and access management system if the user is authorized to access a service or application based on the received access behavior of the user; and
updating the security model of the artificial intelligence-powered identity and access management system based on the access behavior of the user and other users.

18. The non-transitory computer-readable storage medium according to claim 17, further comprising:
receiving the updates for the security model of the artificial intelligence-powered identity and access management system from an intelligent adaptive security system, the intelligent adaptive security system configured to update the security model of the artificial intelligence-powered identity and access management system based on the access behavior of the user and the other users and learned models associated with an adaptive enforced security model for the user and the other users.

19. The non-transitory computer-readable storage medium according to claim 17, wherein the updates for the security model of the artificial intelligence-powered identity and access management system are based on data from the user and the other users from one or more of a federation protocol, an artificial intelligence system with deep learning, triggered multi-factor authenticators, user activity from logs and event logs, transport layer security, human interface device, and decision tree-based security posture.

20. A multifunction printer comprising:
a processor configured to:
receive an access behavior of a user;
input the received access behavior of the user into an artificial intelligence-powered identity and access management system;
receive a determination from a security model of the artificial intelligence-powered identity and access management system if the user is authorized to access a service or application based on the received access behavior of the user; and
update the security model of the artificial intelligence-powered identity and access management system based on the access behavior of the user and other users.
